(19) United States
(12) Patent Application Publication
(10) Pub. No.: US 2013/0007677 A1
(43) Pub. Date: Jan. 3, 2013

(54) Method of implementing IEC 61131-3 control specification through verilog HDL description for modeling, simulation and synthesis of control logic configuration for integrated circuit implementation

(76) Inventor: Prashant Nilkund, Mumbai (IN)

(21) Appl. No.: 13/261,350

(22) PCT Filed: Aug. 27, 2010
(86) PCT No.: PCT/IN2010/000563

§ 371 Date: Jun. 29, 2012

(51) Int. Cl. G06F 17/50

(52) U.S. Cl. 716/102

(57) ABSTRACT

The present invention relates to a method of implementing an IEC 61131-3 control specification through Verilog HDL description comprising the steps of (a) creating user interface for the control specification including languages covered under the IEC 61131-3, particularly ladder diagram, functional block diagram, sequential flow charts, structured text or instruction set listing; (b) generating a list of network interconnections with reference to the above referred languages; (c) generating logic equations using the aforesaid list of network interconnections generated at step (b) above; (d) generating Verilog HDL code snippets in accordance with the IEC 61131-3; (e) generating Verilog HDL code representing hardware with PLC functionality through said control specification by using the Verilog HDL code snippets generated at step (d), the logic equations at step (c) and the network interconnections at step (b).

### TECHNICAL FIELD

The present invention relates to a method of implementing IEC 61131-3 control specification through VERILOG HDL description for modeling, simulation, synthesis and faster glitch free control response logic configuration for implementation on integrated circuits including FPGA devices, IP cores and Application Specific Integrated Circuits (ASICs).

### BACKGROUND OF THE INVENTION

Industrial Automation is the process of using control systems and information technology in machines generally used in mass-scale production to reduce and eliminate need of human intervention in handling the machinery. The dynamics of industrial growth and novel areas of work have expanded industrial automation to integrate numerous fields with both analog as well as digital applications. These include various control systems and their derivatives. The most important distinction among control systems happens to be about the control logic utilized. The control methodology adapted can be analog or digital. Although both controls can work to provide correct output, use of digital control techniques has enabled direct interface using present digital communication protocols with other machines working on Boolean Logic such as personal computers, terminals, and Ethernet networks and so on. This has created tremendous opportunities in the field of industrial and factory automation. The digital control of industrial automation is done mostly by utilizing microprocessor based programmable logic controller (PLC) devices. These digital controllers use sequential. Boolean Logic to define, regulate and maintain various processes encountered in industrial automation. The absence of moving parts and lesser sensitivity on analog inputs makes these devices more robust and easier to handle. The programmable logic controllers and their applications are described next.

A programmable logic controller is a user friendly, microprocessor based specialized computer that carries out control functions of many types and levels of complexity. Its main purpose is to monitor critical process parameters and adjust operations accordingly. A PLC is capable of controlling any system that has discrete digital inputs and outputs. The PLC operation is sequential in nature. It operates through alternating cycles of reading the inputs, executing the program and writing back the outputs. There is an internal program memory that stores the sequential steps of execution and which is programmable using a vendor specific programmer that makes the PLC device very flexible and easy to reconfigure. There are various techniques in use to describe the PLC functionality mainly dependent upon PLC vendors and their individual tools.

International Electro-technical Commission issued the standard IEC 61131-3 which comprises of guidelines for PLC programming. Although each PLC device is vendor specific and generally can be programmed using only vendor dependent tools, it was possible to standardize the input programming styles and methods so that the programming logic design can be made vendor independent. Thus the standard defined in IEC 61131-3 drafted standardized methodologies independent of the PLC device vendors. There are five most important methodologies adopted by majority of PLC vendors that the standard IEC 61131-3 includes. They include both graphical and textual input types. The Ladder Diagrams, Functional Block Diagrams and Sequential Flow Charts comprise the three Graphical Languages, while the Structured Text and Instruction Set Listing form the two Textual Languages. The most widely used subset of IEC 61131-3 is the one which includes Ladder Diagrams and Functional Block Diagrams. These input methodologies arc described below.

Ladder Diagram is a programming language used to program PLC devices which represents the logic by a graphic diagram based on circuit diagrams of relay based logic hardware. Ladder Diagrams are widely used in Industrial Control Applications where sequential control of a process or manufacturing operation is required. It is important for simple but critical control systems and reworking of older relay logic hardware. Ladder Diagrams are best suited for the control problems which have only binary variables and where the main problem is of interlocking and sequencing of binary flow of information.

A Functional Block Diagram is a diagram that represents outputs as a function of inputs. A function is described as a set of elementary blocks. Input and output variables are connected to blocks by interconnection lines. The control flows from left to right and from inputs to outputs. Since Functional Blocks are more flexible and accommodate complex operations, they are used to model complex analog and digital operations.

Sequential Flow Charts (SFC) are derived from IEC 60848 specification standard for documentation and adopted to a set of execution control elements for a programmable control program organization unit for the purpose of performing sequential control functions. The SFC elements provide a means of partitioning a programmable controller program organization unit into a set of steps and transitions interconnected by directed links. Associated with each step is a set of actions, and with each transition is associated a transition condition. Since SFC elements require storage of state information, the only program organization units which can be structured using these elements are function blocks and programs.

Structured Text consists of expressions, statements and functions. Expression is a construct made up of Operands which when evaluated yields a value corresponding to one of the data types specified in the IEC 61131-3. Each Expression is evaluated on level of Operands in a manner of precedence defined in the standard. Various Statements regulate Sequential Control Flow of the operations. The types of Statements include assignment, control, iteration and selection. Accordingly the program is directed.

An Instruction Set List is composed of a sequence of instructions. Each instruction begins on a new line and contains an operator with optional modifiers, and, if necessary for the particular operation, one or more operands separated by commas. Functions and Function Blocks of Instructions are also incorporated in this standard so as to facilitate sequential instruction execution.

Such described digital control of Industrial Automation is implemented mostly with microcontroller or ASIP (Application Specific Instruction Set Processor) based Programmable Logic Controller (PLC) devices. Its main purpose is to monitor critical process parameters and adjust process operations accordingly. These digital controllers operate sequentially, solving the Boolean Logic to define, regulate and maintain various processes encountered in industrial automation. It consists of alternating cycles of reading the inputs, executing the program and writing back the outputs. This basic method of cyclic operation limits its ability to provide faster control response.

A Field Programmable Gate Array or FPGA device is an integrated circuit that is designed to be configurable at hardware level after manufacturing. The configuration of the FPGA is specified by any Hardware Description Language commonly used to describe an integrated circuit. FPGA can be used to implement any Boolean logic function. The ability to update functionality, partial run-time-reconfiguration and low non-recurring costs make FPGAs attractive choices for many applications and ideal for high speed automation. FPGA device structure consists of Programmable Boolean Logic Blocks called Logic Cells and a complex assortment of interconnections (interconnecting conducting wires) that allow the Logic Cells to be connected in any manner described. Various types of complex combinational and sequential functional logic can be implemented on FPGA devices using these Logic Cells and interconnections. The description of such logic circuits is given in a special standard referred to as a Hardware Description Language. There are numerous advantages of FPGA devices over their alternatives which are described next.

FPGA devices offer many advantages when compared to their major competitors' viz. the Application Specific Integrated Circuits and Microprocessor based Systems. These advantages include flexible development of solutions by using dedicated functional blocks such as digital signal processing blocks; reduced cost and time of development; and reduced risk by creating reusable Intellectual Property out of implementations on FPGA devices. One of the important advantages of FPGA devices derives from the fact that these devices can implement sequential and combinational logic together on a single chip in parallel. This means parallel processing of various parts of a single process in the most flexible way possible. The FPGA devices thus provide fastest and most flexible solution for implementing any digital functionality at low cost. When discussing the advantages of FPGA devices it is important to note that the functionality of an FPGA device is described in a Hardware Description Language which makes it vendor independent. One of the most important HDLs is VERILOG HDL which described below.

Verilog is a Hardware Description Language used to describe the functional model of an electronic system. Verilog HDL is most commonly used in design, verification and implementation of digital logic based integrated circuits at register transfer level of abstraction. It is also used in verification of analog and digital circuits. Verilog HDL was described by the IEEE standard 1364, the latest being 1364-2005. Verilog HDL is a general purpose hardware description language that is easy to learn and use. It is similar in syntax with C programming language. Verilog HDL allows different levels of abstraction to be mixed in same model. It also supports parallelism and hierarchical design. Most popular logic synthesis tools and all fabrication vendors of FPGAs support Verilog HDL. The Verilog HDL is very much suitable to handle highly complex digital circuits with very fast response requirements. Any sequential or combinational logic can be comprehensively modeled in Verilog HDL. Verilog HDL can be used to describe Boolean Logic circuit implementations in FPGAs.

Synthesis is a process where a Verilog HDL code is compiled and translated into logic gates and interconnections according to the device specific technology used viz. FPGAs or ASICs. Verilog HDL also allows description of concurrent systems i.e. various systems described and implemented together those work at the same time.

Verilog HDL language is used with two important goals, to describe and simulate an electronic design and to synthesize such a design for various devices. IEEE standard 1364 defines a subset of Verilog HDL that is considered synthesizable. An electronic design described using IEEE 1364 is directly synthesizable for any FPGA device.

### OBJECT OF THE INVENTION

After considering the background of Industrial Automation, PLC devices, its programming, FPGA devices and their configuration, it is proposed that the FPGA devices could be used in control applications. Also the created synthesizable Verilog HDL file can be implemented as integrated circuit on FPGAs, ASICs or used as an IP core. To achieve this goal it is necessary to convert a control specification of a PLC device into the hardware description for an FPGA that is synthesizable and satisfying special needs of control and automation applications. This leads to a system that will generate equivalent IEEE standard 1364 based synthesizable Verilog HDL code from a PLC based system described with IEC 61131-3 which will be implemented into integrated circuits including FPGA devices, IP cores and ASICs.

### DESCRIPTION OF THE INVENTION

The present invention comprises of Input compliant with IEC 61131-3 which is converted into IEEE 1364 synthesizable Verilog HDL code for implementation into integrated circuits including FPGA devices, IP cores and ASICs.

The present invention relates to a method of implementing an IEC 61131-3 control specification through Verilog HDL description comprising the steps of (a) creating user interface for the control specification including languages covered under the IEC 61131-3, particularly ladder diagram, functional block diagram, sequential flow charts, structured text or instruction set listing; (b) generating a list of network interconnections with reference to the above referred languages; (c) generating logic equations using the aforesaid list of network interconnections generated at step (b) above; (d) generating Verilog HDL code snippets in accordance with the IEC 61131-3; (e) generating Verilog HDL code representing hardware with PLC functionality through said control specification by using the Verilog HDL code snippets generated at step (d), the logic equations at step (c) and the network interconnections at step (b).

The generation of the Verilog HDL code at step (e) above includes the steps of (a) assigning all the input and output ports in the Verilog HDL code to be generated; (b) generating process statements to represent the logic equations; (c) instantiating individual modules depending on the Verilog HDL code snippets; and connecting the instantiated modules at step (c) above with the inputs and outputs of step (a) above.

A preferred embodiment of creating the user interface comprises the step of designing entry options and background processes to create these languages.

A further preferred embodiment of the present invention also comprises of a computer implemented method of designing an integrated circuit, IP Core or FPGA hardware description using the methods described above.

A preferred embodiment of the present invention will now be described with reference to the figure accompanying the specification wherein:

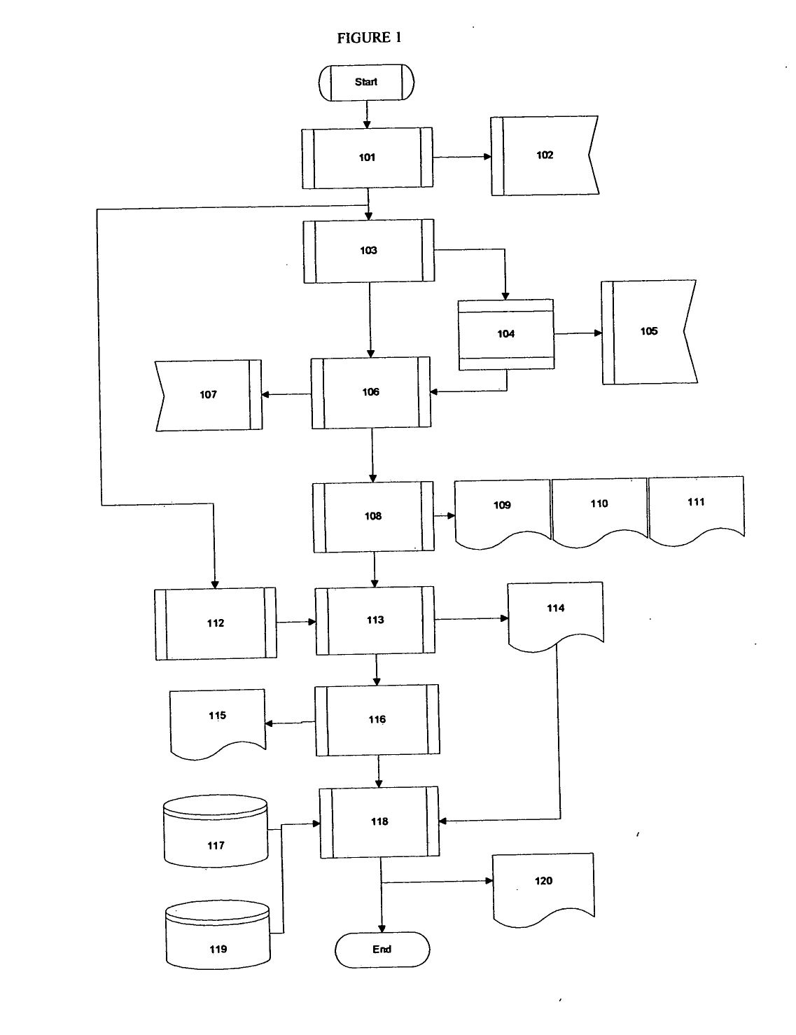

FIG. 1 shows the flowchart embodying a preferred embodiment of the present invention.

Referring to the FIG. 1, the process can be split into various sub-processes, each of which converts IEC 61131-3 input partially into Verilog HDL. The steps are broadly described as follows:
Step 1. Create Graphical User Interface and background processes for creating IEC 61131-3 compliant inputs from user (101).
Step 2. Add IEC 61131-3 compliant Graphical Input Languages viz. Ladder Diagram, Functional Block Diagram or Sequential Flow Chart inputs in GUI and store them in internal temporary storage locations (103).
Step 3. Save Ladder Diagram data (108) into LDD (Ladder Diagram Description) file (109); Functional Block Diagram data into FBD (Functional Block Description) file (110); and Sequential Flow Chart data into SFC (Sequential Flow Chart Description) (111) for subsequent storage and retrieval.
Step 4. Generate network interconnections from saved LDD/FBD/SFC file (113) and store in a NST (Netlist Storage for Translation) file (114).
Step 5. Generate network interconnections from Textual Languages described from IEC 61131-3 viz. Structured Text (stored as .STX file) and Instruction Set Listing (stored as .ISL file) Textual inputs (112) and store in a NST file (114).
Step 6. Analyze NST file for element-level interconnections and generate Logic Equations equivalent to the given Ladder Diagram (116). Store the equations in EQU (Logic Equations) file (115).
Step 7. Create and store Verilog HDL code snippets (code fragments) for generalized Verilog HDL file structure (119). Create and store Verilog HDL modules for Timer and Counter Elements of a Ladder Diagram and all elementary Functional Blocks of a Functional Block Diagram and all other constituents of languages described in IEC 61131-3 (117).
Step 8. Use Verilog HDL code snippets, Verilog HDL code modules, EQU file and NST file to generate synthesizable Verilog HDL code that represents the IEC 61131-3 description (118). Add interconnections accordingly. Store it as a Verilog HDL (.V) file (120).
Step 9. Use the Verilog HDL file as an input to a FPGA device-specific synthesis tool and implement the. Verilog HDL file as a circuit description in FPGA device.

The FPGA loaded with the synthesized Verilog HDL file emulates PLC device behavior described using IEC 61131-3 based input specifications.

The system proposed here consists of input compliant with IEC 61131-3 which is converted into IEEE 1364 synthesizable Verilog HDL code for implementation into FPGA device. The system steps to get the desired result are explained below:

Step 1

The Graphical User Interface consists of creating design entry options and background processes to create. Ladder Element representations, Functional Block representations and Sequential Flow Chart representations on User Interface along with various data variables to store element and block specific information.

Each element/block is drawn on the canvas as a picture retrieved from pre-stored pictures. The variables that are used for temporary storage store data values for example, initial Boolean Value, Element Number, Description, Name, Position, No. of Input ports, No. of Output ports etc.

Each Element data is stored in a dedicated structure element in the background process of GUI. The data also includes total number of elements present in a Diagram. These data storage elements, the window for GUI and various graphic elements are created in this step.

Step 2

The GUI with data integration capabilities can be used to include, store, change and retrieve individual Graphical User Input in a generalized manner. These elements also create new element specific routines at inception and store the associated data as inputted by the user. Once all the elements are created on the blank canvas and their respective data stored in place, the interconnections arc added. The interconnections could be added and simultaneously stored to create complete Ladder Diagrams, Functional Block Diagrams and Sequential Flow Charts. The start points and end points of these interconnections are stored for respective elements. These points help in creation and understanding of a network of such elements together.

Before proceeding further, it is necessary to check the network for connectivity and errors. Error checking is done in two phases, Design Rule Checking and Logical Error Checking. Most of the Logic Errors are preempted by using well defined placement of Ladder Elements, Functional Block Diagrams and Sequential Flow Charts. Once it is made sure that the Diagrams are created in accordance with IEC 61131-3 we can use them for further processing.

Step 3

Ladder Diagram data is stored in a file format specified as .LDD (Ladder Diagram Description); Functional Block Diagram as .FBD (Functional Block Description) and Sequential Flow Chart as .SFC (Sequential Flow Chart Description). These files include one element parameters per line in the form of character strings. These are fully retrievable representations of the original Diagram. These are stored along with the respective Diagram's image file.

Each LDD file contains consecutive data associated with each Ladder Element in the order of their creation. Each line belongs to a single element. The data is fetched from the temporary storage provided with the GUI. At the end of a LDD file the metadata about the entire Ladder Diagram is stored. This metadata includes number of elements in the ladder, number of interconnections and number of Functional Blocks if any. The Ladder Diagram is completely retrievable from the stored LDD file.

Each FBD file contains consecutive data associated with each Functional Block in the order of their creation. Each line belongs to a single Functional Block. It includes number of inputs, number of outputs and the type of the Functional Block. The data are collected from the temporary storage of GUI used to input the Functional Block Diagram. At the end of a FBD file the metadata about the entire Functional Block Diagram is stored. This metadata includes number of Blocks in the diagram, number of interconnections etc. The Functional Block Diagram is completely retrievable from the stored FBD file.

Each SFC file contains consecutive data associated with each Step and Transition denoted by a single SFC element. Each line belongs to such SFC element. It includes number of inputs, number of outputs and the description of the SFC element to be added by the user. The data are collected from the temporary storage of GUI used to input the Sequential Flow Chart. At the end of a SFC file the metadata about the entire Sequential Flow Chart is stored. This metadata includes number of SFC Elements in the diagram, number of interconnections etc. The Sequential Flow Chart is completely retrievable from the stored SFC

Step 4

Netlist Storage for Translation or .NST file contains basic interconnectivity representations of the original Ladder Diagram, Functional Block Diagram or Sequential Flow Chart in terms of point to point connections. The elements are considered to be lines while the interconnections stand for individual nodes. Thus the complete map of interconnections can be derived from .LDD, .FBD and .SFC files. This information is stored in .NST file.

Each NST files stores information of every element's starting point and ending point. Each interconnection is regarded as a common point referred to as a node. Every Ladder Element has one input and one output port. Hence each element has two nodes for connections. In case of Functional Block Diagrams, there are multiple input and output ports. Thus they have multiple nodes for connections. Sequential Flow Charts include multiple input multiple output SFC elements. Thus they also exhibit multiple nodes.

It is important to note that all the points on Power rung form a common power node and all the points on Ground rung form a common ground node.

Along with the connectivity of each element or functional block the NST file also stores element/block type/SFC element type and any variable data related to it.

Step 5

Structured Text and Instruction Set Listing inputs are gathered from the User and stored in the textual format defined in ANSI standard codes in .STX and .ISL files respectively. These inputs are used to create Netlist Files (.NST) by process of search and substitution of individual files. The resulting NST file adheres to the format as described in Step 4 and is compatible with the other NST files generated from the (.LDD)/(.FBD)/(.SFC) file inputs.

Step 6

Logic Equations can be derived from the netlist of interconnects mapped in .NST file. This process uses the inter-nodal connections and individual element level connections to generate structured textual representation of the network of elements. The iterative process to combine the elements logically as per their interconnections leads to revisions in elemental data by their logical counterparts. End of the process generates unique Boolean logical equations per single power transfer path (path from single unique point on Power rung to single unique point on Ground rung) that represent the Ladder Diagram input from GUI.

For a Ladder Diagram the Netlist is used to create these Logic Equations. For a Functional Block Diagram, the Logic Equations File stores merely which inputs of one block are connected to which outputs of next block. The Equations for FBD are merely textual representations of netlist interconnections. Sequential Flow Charts also exhibit similar representations as the Functional Block Diagrams. Logic Equations for Textual Inputs of IEC 61131-3 represent the Boolean Logic in the respective control specifications in accordance with the flow of control.

These equations are stored in .EQU file and are completely retrievable.

Step 7

Various Verilog HDL snippets are created and stored in advance. These snippets or partial codes are in compliance with IEEE standard 1364. Further the modules for elementary functional blocks of Functional Block Diagram, Sequential Flow Chart elements according to their descriptions, Instructions from Instruction Set Listings, Statements from Structured Texts and variable delay timer components and counter components of Ladder Diagram are preconceived, written in advance and tested beforehand. These modules are simulated and tested for their independent functionality and are ready to be instantiated in the Verilog HDL description of any input constituent of all possible IEC 61131-3 languages.

These code snippets are used later as readymade building blocks to create an arbitrary HDL file respective to the input Diagrams or Textual Listings.

Step 8

The NST file and EQU file are used for understanding the IEC 61131-3 inputs and the interconnections within them. Accordingly, port descriptions, processes and components are added to the resultant Verilog HDL file. Each logic equation represents a single rung and hence is incorporated as a process in the Verilog HDL file. Timer/Counter/Elementary Block components/SFC elements etc are added as per their interconnections. Verilog HDL code snippets from Step 6 are used to fulfill syntactic requirements of IEEE standard 1364. The Verilog HDL file thus generated emulates behavior specified in input IEC 61131-3 control specification.

Step 9

The Verilog HDL file generated in Step 7 is ready to be synthesized for any FPGA device. A logic synthesis tool specific for the FPGA device is used to generate bit information file for the specific FPGA device using the generated Verilog HDL file description. The FPGA device loaded with the particular bit information file using JTAG interface can be used to emulate, model or simulate the PLC device whose functionality was described in input IEC 61131-3 control specification. The Verilog HDL file generated from Step 7 can be directly used for the same purpose in a Verilog HDL simulator tool or added as a module in a Verilog HDL description of System-on-chip.

Uses

The synthesizable Verilog HDL file implemented in an FPGA device emulates PLC device behavior. Thus it can be used to replace a PLC device with existing control specifications specified in IEC 61131-3. Further, the method can be used to convert any IEC 61131-3 based input into a device independent synthesizable Verilog HDL code compliant with IEEE standard 1364. This Verilog HDL code can be used to simulate and analyze behavior of a PLC device before implementation. Also, the generated Verilog HDL file has a main module which can be instantiated and incorporated in a programmable System-on-chip description of a Verilog HDL system with a PLC component, to directly replace the PLC device in question. Using the Verilog HDL file so generated a PLC component can be replaced by an FPGA device.

Although the invention has been described in terms of particular embodiments and applications, one of ordinary skill in the art, in light of this teaching, can generate additional embodiments and modifications without departing from the spirit of or exceeding the scope of the claimed invention. It should be emphasized that the above-described embodiments of the present invention, particularly any “preferred” embodiments, are merely possible examples of the invention of implementations, merely set forth for a clear understanding of the principles of the invention. Accordingly, it is to be understood that the drawings and descriptions herein are preferred by way of example to facilitate comprehension of the invention and should not be construed to limit the scope thereof.

1) A method of implementing an IEC 61131-3 control specification through Verilog HDL description comprising the steps of:
a) creating user interface for said control specification including at least a language covered under said IEC 61131-3;
b) generating a list of network interconnections with reference to said language in step (a) above;
c) generating logic equations representing said list of network interconnections generated at step (b) above;
d) generating Verilog HDL code snippets in accordance with said IEC 61131-3;
e) generating Verilog HDL code representing hardware with PLC functionality through said control specification by using said Verilog HDL code snippets generated at step (d), said logic equations at step (c) and said network interconnections at step (b).

2) A method of implementing an IEC 61131-3 control specification through Verilog HDL description as claimed in claim 1, wherein generation of said Verilog HDL code at step (e) comprises the steps of:
a) assigning all the input and output ports in said Verilog HDL code to be generated;
b) generating process statements to represent said logic equations;
c) instantiating individual modules depending on said Verilog HDL code snippets generated at step (d) of claim 1;
d) connecting said instantiated modules at step (c) above with said inputs and outputs of step (a) above.

3) A method of implementing an IEC 61131-3 control specification through Verilog HDL description as claimed in claim 1, wherein said languages include ladder diagram, functional block diagram, sequential flow charts, structured text or instruction set listing.

4) A method of implementing an IEC 61131-3 control specification through Verilog HDL description as claimed in claim 1, wherein said user interface comprises the step of designing entry options and background processes to create control specification using said languages.

5) A computer implemented method of designing an integrated circuit, IP Core or FPGA hardware configuration comprising the steps of
a) creating user interface for said control specification including at least a language covered under said IEC 61131-3;
b) generating a list of network interconnections with reference to said language in step (a) above;
c) generating logic equations representing said list of network interconnections generated at step (b) above;
d) generating Verilog HDL code snippets in accordance with said IEC 61131-3;
e) generating Verilog HDL code representing hardware with PLC functionality through said control specification by using said Verilog HDL code snippets generated at step (d), said logic equations at step (c) and said network interconnections at step (b).

6) A computer implemented method of designing an integrated circuit, IP Core or FPGA hardware description as claimed in claim 5, wherein generation of said Verilog HDL code at step (e) comprises the steps of:
a) assigning all the input and output ports of said Verilog HDL code to be generated;
b) generating process statements to represent said logic equations;
c) instantiating individual modules depending on said Verilog HDL code snippets generated at step (d) of claim 1;
d) connecting said instantiated modules at step (c) above with said inputs and outputs of step (a) above.

7) A computer implemented method of designing an integrated circuit, IP Core or FPGA hardware description as claimed in claim 5, wherein said languages include ladder diagram, functional block diagram; sequential flow charts, structured text or instruction set listing.

8) A computer implemented method of designing an integrated circuit, IP Core or FPGA hardware description as claimed in claim 5, wherein said user interface comprises the step of designing entry options and background processes to create said languages.
